(19) United States
(12) Patent Application Publication
(10) Pub. No.: US 2011/0119101 A1
(43) Pub. Date: May 19, 2011

(54) Case Management Services

(75) Inventor: Stephen Drury, Fleetwood (GB)

(73) Assignee: ACCENTURE GLOBAL SERVICES GMBH, Schaffhausen (CH)

(21) Appl. No.: 12/834,149

(22) Filed: Jul. 12, 2010

Related U.S. Application Data
(60) Provisional application No. 61/260,980, filed on Nov. 13, 2009.

(51) Int. Cl. G06Q 10/00

(52) U.S. Cl. 705/7.13; 705/320

(57) ABSTRACT

Methods, systems, and apparatus, including computer programs encoded on a computer storage medium, for automatically routing and managing human resource requests. A method includes receiving a work ticket including a ticket identification code, a request type, a submission date, and an employee identification code from a workforce management engine, the work ticket being associated with a human resource request submitted by an employee at a human resource portal; assigning a case identification code to the work ticket; associating a work flow with the case identification code, the work flow including a status condition, and at least one work flow task associated with a workflow task event; and transmitting an update to the workforce management engine, the transmitting triggered by the work flow task event.

### CROSS-REFERENCE TO RELATED APPLICATION

This application claims the benefit of U.S. Application Ser. No. 61/260,980, filed on Nov. 13, 2009, which is incorporated by reference in its entirety.

### TECHNICAL FIELD

The present disclosure generally relates to human resource case management.

### BACKGROUND

Human Resource (HR) departments can apply a variety of software tools to assist in various aspects of HR management including, in some examples, a payroll system, a benefits system, a timekeeping system, a training system, a recruiting system, or a performance management system. An HR management system can incorporate two or more of these systems as modules of an over-arching system, sharing a central database between the modules. The HR department may additionally support an employee self-service system, where an employee can access personal information pertaining to one or more of the systems managed by the HR department, for example through a browser-based tool.

In large organizations, the HR department is frequently made up of multiple local HR departments, each local HR department potentially using different types of systems. For example, in a retail conglomerate, the timekeeping system of individual brick and mortar store employees may vary dramatically from the timekeeping system applied to the employees working at the head office. Furthermore, in an international conglomerate, the benefits system and payroll system may vary from country to country, for example due to local tax codes.

### SUMMARY

In general, one innovative aspect of the subject matter described in this specification may be embodied in methods that include the actions of receiving, at a human resource portal, a human resource request regarding an employee, the human resource portal including a graphical user interface, the human resource request including a request type and an employee identification code, receiving, at a workforce management engine, the human resource request from the human resource portal, and generating a work ticket, the work ticket including a ticket identification code and a submission date of the human resource request, receiving, at a case management engine, the work ticket from the workforce management engine, assigning a case identification code to the work ticket, and associating a work flow with the work ticket, the work flow including a status condition, and at least one work flow task associated with a workflow task event. The method also includes the actions of transmitting an update to the workforce management engine, the updated triggered by the work flow task event, the update associated with update information including the ticket identification code, and a status code associated with the status condition, and providing, through the workforce management engine, a portion of the update information to the human resource portal for display through the graphical user interface.

Other embodiments of this aspect include corresponding systems, apparatus, and computer programs, configured to perform the actions of the methods, encoded on computer storage devices.

These and other embodiments may each optionally include one or more of the following features. For instance, the request type is a planned leave type, and the case management engine includes a manage planned leave engine configured to receive a request date range associated with the human resource request, create an approval for leave work flow task, and issue an approval for leave work flow task event to the workforce management system, a modification of leave engine configured to receive a modification of date range associated with the human resource request, create a modification of leave work flow task, and issue an action item to the workflow management system, and a return to work engine configured to issue updated information to the workforce management system, the issuance of the updated information being triggered by a workflow task event scheduled by the case management system for the end of the request date range; the work flow includes work flow task events triggering a passing of control of management of the work flow between the manage planned leave engine, the modification of leave engine, and the return to work engine; the actions further include issuing an action item to of one of a computer messaging account of a direct supervisor of the employee, a payroll department, or a computer messaging account of a human resource liaison regarding the human resource request; the employee submits the human resource request to a workplace management worker and the workplace management worker enters the request through the human resource portal; the actions further include assigning a case worker to the work ticket; and the work flow task events further include an alert event targeted to the a computer messaging account associated with the case worker assigned to the work ticket; the update information further includes update message text, and the portion of the update information available for display through the graphical user interface includes the request ticket identification code, the status code, and the update message text; the update message text includes information received by the case management engine from a computer messaging account associated with a direct supervisor, an HR liaison, a workforce management worker, or a case worker; the update is a request ticket closure event, and the actions further include modifying the status condition to one of closed prior to the providing, and closing the work ticket; the actions further include determining whether the human resource request is a duplicate human resource request; a work flow type of the work flow is one of an employee absence administration type, an exit administration type, a safety or security incident event administration type, a conduct administration type, a performance administration type, or an employee interrelations incident administration type; the case management engine is included within a human resources administration engine, the human resources administration engine further including a workforce and data administration engine, a payroll engine, and a benefits engine, and the case management engine is configured to issue action items or provide information to the workforce and data administration engine, the payroll engine, or the benefits engine; the case management engine is further configured to track a total amount of leave requested by the employee and to determine when the total amount of leave requested by the employee exceeds a threshold leave value; the case management engine is further configured to submit a human resource request to the workforce management engine regarding the total amount of leave when the total amount of leave requested by the employee exceeds the threshold leave value; and/or the case management engine is further configured to generate trend reports associated with each work flow type.

Particular embodiments of the subject matter described in this specification may be implemented to realize one or more of the following advantages. Specifically, human resource tasks can be automatically assigned to appropriate personnel, and reminders or updates can be issued to interested parties automatically through work flow task events. Other modules within the human resource system, such as payroll or benefits administration, can be automatically updated and adjusted by the case management system through work flow task events. Trends within individual locations or in the overall organization can be tracked and analyzed to identify potential problems. Employees can track open human resource requests, accessing up-to-date status information regarding individual requests. The work load of individual HR case workers can be automatically balanced through automated task assignment.

The details of one or more embodiments of the subject matter described in this specification are set forth in the accompanying drawings and the description below. Other potential features, aspects, and advantages of the subject matter will become apparent from the description, and the drawings.

### BRIEF DESCRIPTION OF DRAWINGS

Referring now to the drawings, in which like reference numbers represent corresponding parts throughout:

FIG. 1 is a system flow diagram illustrating an example series of events that occur in the handling of a human resource request within a human resource case management system;

FIG. 2 is a block diagram illustrating the service components involved in managing talent within an organization through a human resource department;

FIG. 3 is a block diagram illustrating an example service structure within a human resource department;

FIG. 4 is an example user interface for interfacing with a human resource case management system;

FIG. 5 is a flow chart illustrating an example process for handling a human resource request within a human resource case management system;

FIG. 6 is a schematic diagram of an exemplary computer system.

### DETAILED DESCRIPTION

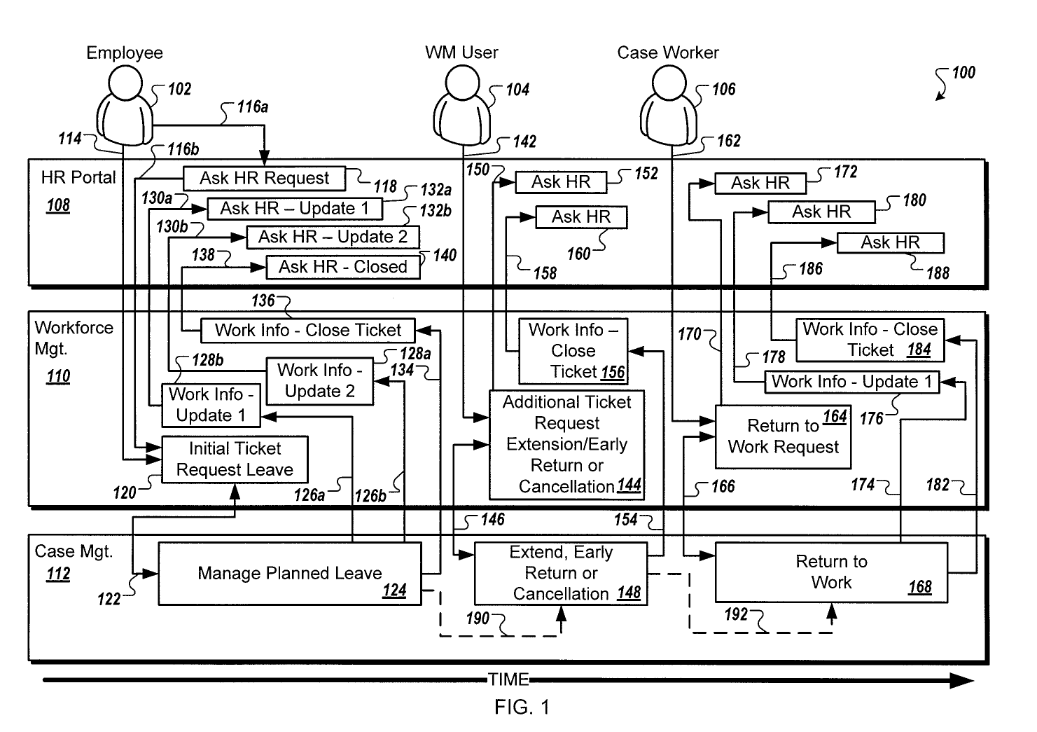

FIG. 1 is a system flow diagram 100 illustrating an example series of events that occur in the handling of a human resource request (e.g., a leave request, a grievance request, or other request) within a human resource (HR) case management system. The HR case management system can track the progress of an employee request submitted within the HR department through various stages while providing the employee with up-to-date status regarding the request.

An employee 102 interfaces with the HR case management system through an HR portal 108. The request is communicated from the HR portal 108 to a workforce management system 110. The request is received by a workforce management worker 104 connected to the workforce management system 110. The workforce management worker 104 reviews the request and forwards the information to an appropriate case worker 106. The case worker 106 thereafter handles the employee request.

Throughout the process, a case management system 112 manages the status and scheduling of events surrounding the request submitted by the employee 102. For example, the case management system 112 ensures that only one active case exists for each case type for an individual employee. In some implementations, if more than one ticket is issued regarding the same employee and the same case type, the case management system 112 creates a task for the case worker group (e.g., within the workforce management system 110) to have the discrepancy investigated and resolved. In other words, a request ticket generated through the workforce management system 110 is matched with a case identification within the case management system 112 and the unique request represented by the request ticket and the case identification is managed by the case management system 100.

The case handling begins when the employee 102 generates 116a a request through the HR portal 108. For example, through a user interface form, the employee submits 116b a request 118 for extended leave to the workforce management system 110. Alternatively, the employee 102 can contact the workforce management group directly 114a, for example through sending an email or making a phone call. Whichever route taken by the employee 102, an initial request ticket for leave 120 is generated within the workforce management system 110.

The workforce management system 110 communicates 122 information regarding the request ticket to the case management system 112. The information, in some examples, can include a request type, an employee identification code, an employee name, an employee group, location, department, or company, a ticket identification code, a submission date, a request date range, or other pertinent information. A planned leave management engine 124 within the case management system 112 creates a case identification and determines a work flow regarding the employee request.

Work flow tasks in the managed planned leave engine 124 trigger the transmission 126 of updates 128 to the request ticket within the workforce management system 110. The transmission, in one example, can include a request ticket identification, employee identification, an updated status code, and update message text (e.g., a personalized message regarding the progress of the request). Any number of updates can be issued between the managed planned leave engine 124 and the workforce management system 110, depending on the series of events determined, in part, by the work flow.

The workforce management system 110 forwards 130 the updated information to the HR portal 108. A series of updates 132 are available to the employee 102 through the HR portal 108 upon accessing information regarding the submitted request. For example, the employee 102 can log into a personal account within the HR Portal 108 to first verify whether or not the request was received and later to determine whether or not the request has been tentatively approved by the employee's supervisor and is awaiting approval from an HR liaison. The information available to the employee 102, in some examples, can include the request ticket identification, status code, and the update message text transmitted by the case management system in transmission 126. In some implementations, the workforce management system 110 maintains information regarding the request ticket which is unavailable for employee review. For example, some sensitive information can be maintained by the HR department without sharing the information with the employee 102 through the HR portal 108.

Along with the illustrated communications, the case management system 112 can send other transmissions directed towards individuals involved in the leave approval process. For example, the managed planned leave engine 124 can transmit information regarding the request to the direct supervisor of the employee 102 or an HR liaison local to the employee 102 to obtain approval for the leave request. The supervisor or the HR liaison, in some examples, can interface with the HR portal 108 or directly with the workforce management system 110 to approve the request through the HR case management system.

Upon completion of the request ticket (e.g., the determination of approval or denial, or upon the end of the leave), the manage planned leave engine 124 triggers 134 a close ticket event 136 within the workforce management system 110. The close ticket event 136 can include, for example, the case identification or request ticket identification, employee identification, status, and update message text. A portion of this information is forwarded 138 by the workforce management system 110 to the HR portal 108, generating a closed update 140 within the HR portal 108. The employee 102 can access the HR portal 108 to review the updated status and additional or update message text provided by the case management system 112 regarding the request ticket. In some implementations, message text includes information which is received by the case management system from a direct supervisor, an HR liaison, the workforce management worker 104, or the case worker 106.

Along with the interaction between the employee 102 and the HR case management system, the workforce management worker 104 can be involved in one or more steps of the HR case management process. For example, upon accessing 142 the workforce management system 110 (optionally via the HR portal 108), the workforce management worker 104 reviews and responds to new request tickets such as the request ticket submitted by the employee 102. In some examples, the workforce management worker 104 can review new request tickets, existing request tickets flagged by the case management system 112 as being duplicates, follow-up request tickets (e.g., for an extension or early return from a leave authorized through a previously submitted leave request), or a cancellation of a request ticket through a request ticket event 144.

In one example, the employee 102 informs the workforce management group of his or her intent to return to the workplace early from the leave that was previously established through the leave request ticket. In some examples, the employee 102 sends an email or calls the workforce management group, or logs into the HR portal 108 remotely (e.g., from home) to submit the request. The workforce management worker 104, in this example, accesses 142 the workforce management system 110 to open a leave modification request ticket. The leave modification request ticket is generated within the request ticket event 144. The workforce management system 110 issues 146 information regarding the leave modification request ticket to the case management system 112.

The case management system 112 can use this information within a modification of leave engine 148. For example, the modification of leave engine 148 establishes a work flow regarding the extension, early return, or cancellation of an employee leave, creates a case identification regarding the leave modification, and responds 146 to the workforce management system 110 with the case identification corresponding to the new request. Additionally, the case management system 112, through the established work flow, can inform interested parties (e.g., direct supervisor, payroll, local HR liaison, etc.) of the details of the leave modification or trigger action items to one or more individuals corresponding to the leave modification request.

The information within the response 146 is provided 150 to the HR portal 108 within an update event 152. Upon access by the employee 102 to the HR portal 108, for example, the employee can determine that a case regarding the early return request has been generated by the HR case management system.

In some implementations, at a future point (e.g., once all interested parties have been informed and any open action items have been resolved), the leave modification engine 148 within the case management system 112 issues 154 information to the workforce management system 110 regarding the closure of the early return case, triggering an leave modification request ticket closure event 156. The workforce management system 110 closes the leave modification request ticket and updates 158 the HR portal 108 regarding the ticket closure, triggering an update 160. At this point, upon access to the HR portal 108, the employee 102 can review closure status of the early return ticket request.

In other implementations, the workforce management system 110 can refer the leave modification request ticket to the case worker 106. For example, upon review by the workforce management worker 104 within the ticket request event 144, the workforce management worker 104 can select an appropriate case worker to resolve the request and refer the early return request to the case worker 106.

Upon access 162 of the case worker 106 to the workforce management system 110, the case worker 106 can review the early return ticket within a return to work request event 164. Upon update by the case worker 106, the workforce management system 110 issues 166 information regarding the return to work request event 164 (e.g., assignment of the case worker 106) to a return to work engine 168 within the case management system 112.

The return to work engine 168 updates information, such as status (e.g., assignment of the case worker 106) or update message text message. The return to work engine 168 can additionally, in some implementations, establish a work flow regarding the employee's return to work and alert other systems or parties as to the return status of the employee 102. The return to work engine 168 issues 166 the updated information to the workforce management system 110.

The workforce management system 110 updates 170 the HR portal 108 with the information, triggering an HR update event 172. Upon access to the HR portal, the employee 102, for example, can now review information regarding the case worker 106 assigned to the return request ticket.

Based upon the established work flow and the activities of the employee 102, the workforce management worker 104, the case worker 106, or other interested parties, at a future point in time, the return to work engine 168 issues 174 updated information to the workforce management system 110. For example, the updated information could concern the addition of a new dependent to the benefits package of the employee 102 due to the result of a maternity or paternity leave. The workforce management system 110 generates a return request ticket update event 176 and issues 178 information regarding the event to the HR portal 108. The information provided to the HR portal 108 triggers an update event 180. Any number of update events can be triggered between the case management system 112, the workforce management system 110 and the HR portal 108 in this manner.

At some point in time, the return to work engine 168 issues 182 information to the workforce management system 110 regarding the closure of the return request case, invoking a close ticket event 184 within the workforce management system 110. The workforce management system 110, in return, issues 186 information to the HR portal 108 regarding the ticket closure. This triggers an update event 188. At this point, upon review by the employee 102 through the HR portal 108, the closure status and any other updated information is available for perusal.

Although the triggering of the leave modification engine 148 and the return to work engine 168 are illustrated as happening in response to actions taken by the employee 102, the workplace management worker 104, and the case worker 106, in some implementations the case management system 112 triggers events passing control between the manage planned leave engine 124, the leave modification engine 148, and the return to work engine 168. For example, based upon the work flow established by the manage planned leave engine 124, control can be passed 190 directly between the manage planned leave engine 124 and the leave modification engine 148. The leave modification engine 148 can, in turn, generate the leave modification work flow which, upon completion of key tasks or upon receipt of key information, passes 192 control to the return to work engine 168. If, in another example, the employee 102 makes no modification to the original leave plans, the manage planned leave engine 124 can pass control directly to the return to work engine 168, for example within a threshold amount of time before the established return date of the employee 102. Other implementations are possible. Although the HR case management system has been described in relation to leave request tickets, other employee case management is possible. In some examples, employee absence administration, exit administration, safety or security incident event administration, conduct administration, performance administration, or employee interrelations incident administration can be conducted through the HR case management system.

Thus, according to the approach illustrated in FIG. 1, a ticket identifier is assigned to a human resources request that has been received from an employee. Information including the ticket identifier and the human resources request is provided to a case management tool. Status information generated by the case management tool is tracked, using the ticket identifier. The status information is provided for display to the employee.

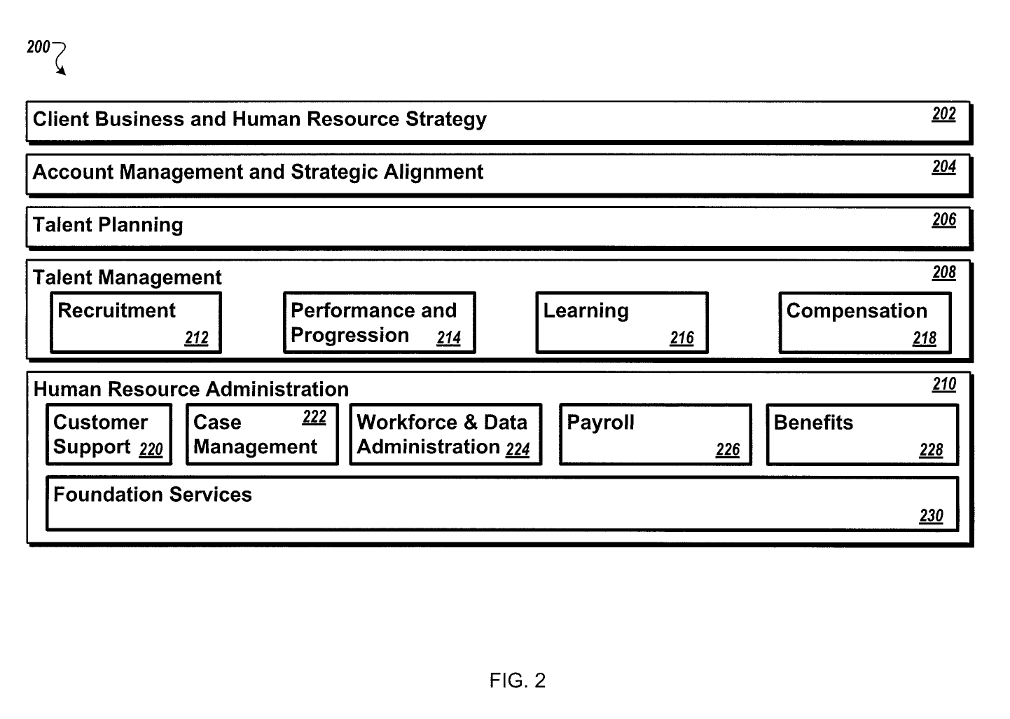

FIG. 2 is a block diagram 200 illustrating the service components involved in managing talent within an organization through a human resource department. The service components include a client business and human resource strategy component 202, an account management and strategic alignment component 204, a talent planning component 206, a talent management component 208, and a human resource administration component 210.

The talent management component 208 includes a recruitment subcomponent 212, a performance and progression subcomponent 214, a learning subcomponent 216, and a compensation subcomponent 218.

The human resource administration component 210 includes a customer support subcomponent 220, a case management subcomponent 222, a workforce and data administration subcomponent 224, a payroll subcomponent 226, a benefits subcomponent 228, and a foundation services subcomponent 230.

The case management subcomponent 222 of the HR administration component 210, for example, can be implemented using the HR case management system as described in relation to FIG. 1. The case management subcomponent 222, in some implementations, automatically interrelates with other systems within the HR administration component or other components of the HR department. For example, the case management subcomponent 222, when dealing with a maternity leave request, can communicate with the benefits subcomponent 228 to determine the maternity leave benefits available to a particular employee. These benefits can include a reduction in pay during the leave of absence. In this case, the case management subcomponent 222 can notify the payroll subcomponent 226 regarding the planned period of reduced pay. Other interrelations between the case management subcomponent 222 and the subcomponents 220, 224, 226, 228, or 230, or the components 202, 204, 206, or 208 are possible.

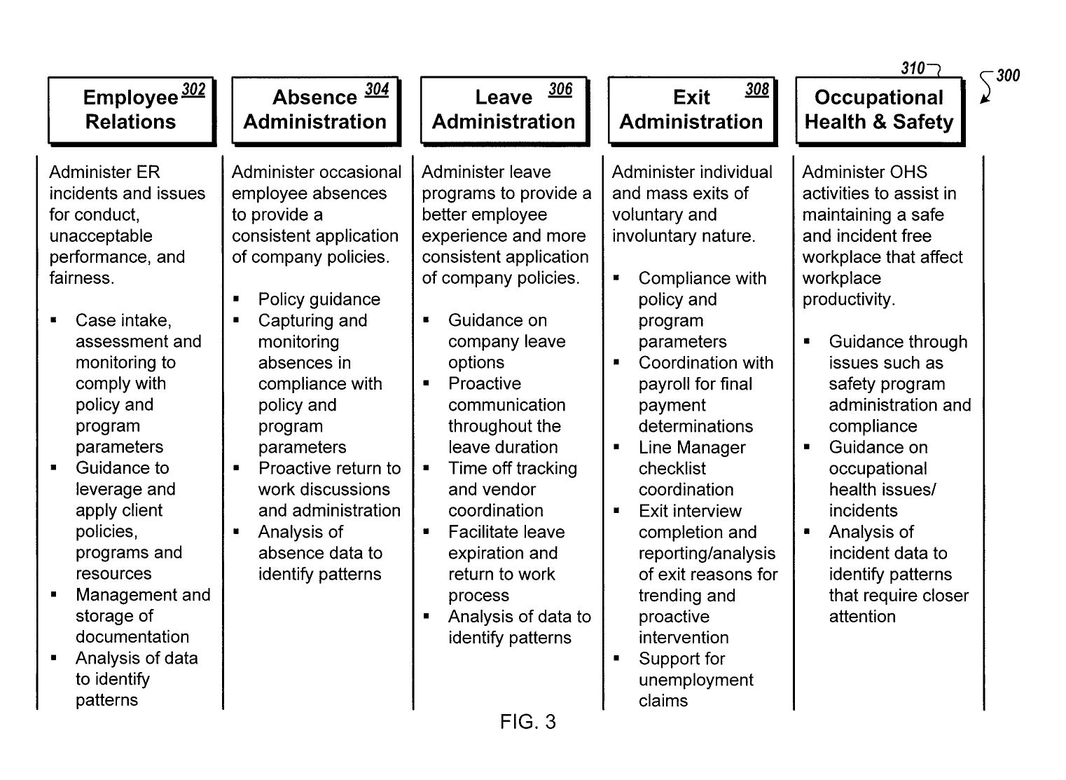

FIG. 3 is a block diagram 300 illustrating an example service structure within a human resource department. An employee relations service 302, an absence administration service 304, a leave administration service 306, an exit administration service 308, and an occupational health and safety service 310 are defined and detailed within the block diagram 300. The services 302, 304, 206, 308, and 310 describe exemplary types of HR services which can benefit from the automated handling provided by the HR security case management system as described in relation to FIG. 1.

In some implementations, due to the consistency and structure provided by the case management system 112, the human resources department can more closely track and report individual HR cases for trend analysis. For example, records regarding the cases established through the HR case management system can be monitored by the case management system to determine threshold situations and to send notifications regarding potential concerns. For example, the case management system 112 can track the total amount of leave requested and approved for the employee 102. If the employee 102 is suspected of an unusually high level of absenteeism, for example, the case management system 112 can, in some embodiments, issue an alert to the corresponding employee or group within the HR department or open a case and a request ticket within the workforce management system 110 regarding the absenteeism rate. In another example, through records collected by the case management system, the HR department can analyze statistics and trends associated with safety incident reports.

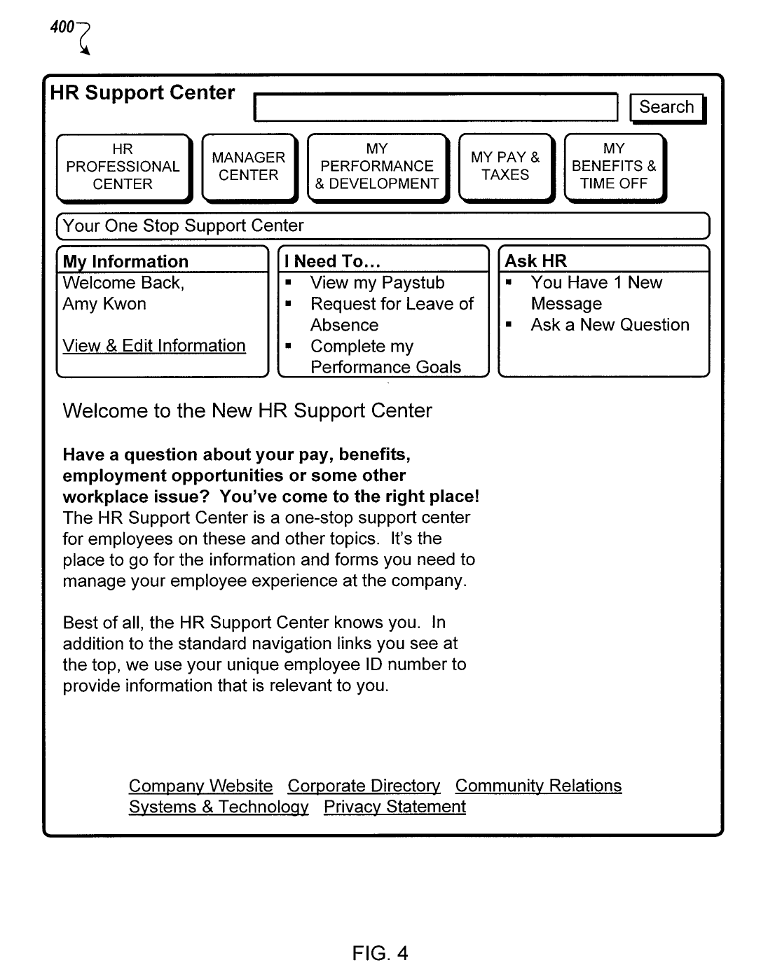

FIG. 4 is an example user interface 400 for interfacing with a human resource case management system. The user interface, for example, can be used by the employee 102 to access the HR portal 108 when initiating and tracking human resource requests through the HR case management system.

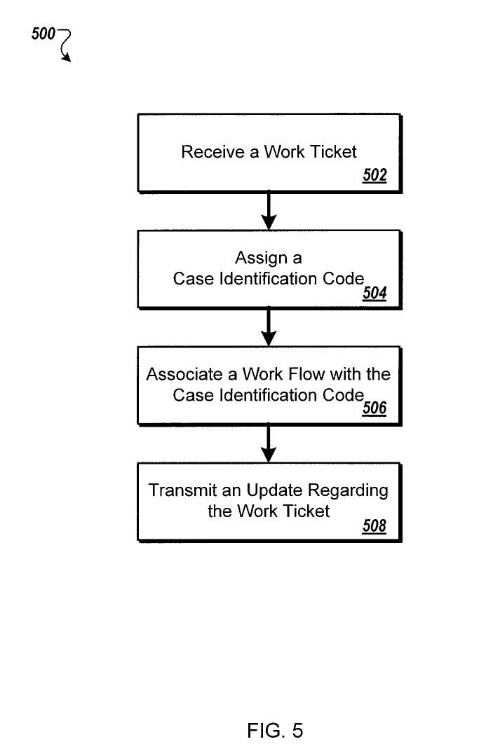

FIG. 5 is a flow chart illustrating an example process 500 for handling a human resource request within a human resource case management system. Briefly, the process 500 describes the initialization and processing of a human resource request by a case management system. When the human resource request, in the form of a work ticket, is routed to the case management system, the case management system associates a work flow with the work ticket to automatically route assignments and reminders regarding the human resource request. Updates to the human resource request, triggered by work flow events, are made visible to a user, such as the employee, through a human resource portal graphical user interface (GUI).

The process 500 begins with receiving a work ticket, associated with a human resource request submitted by an employee, from a workforce management engine (502). The work ticket can include a ticket identification code, a request type, a submission date, and an employee identification code. The human resource request, for example, can be submitted by an employee at a human resource portal through a GUI.

A case identification code is assigned to the work ticket (504). The case identification code can be a new case identification code, or the work ticket can be associated with a previously allocated case identification code. For example, if the work ticket request type is an employee leave request type, a new case identification code can be assigned. If, instead, the work ticket request type is a change of leave request type, the case identification code assigned to the previously submitted leave request type work ticket can be associated with the new request. In some implementations, the work ticket is also reviewed against other work tickets received from the workforce management engine to determine whether the work ticket is a duplicate.

A work flow is associated with the case identification code (506). The work flow can include a status condition and at least one work flow task associated with a workflow task event. For example, the status condition of a shift reassignment (e.g., second shift to first shift) can be initialized to a pending status, pending approval of management. A managerial approval request work flow task can be included in the work flow. A workflow task event, corresponding to issuing an approval request notification to a computer messaging account of the appropriate manager, can be scheduled.

An update is transmitted regarding the work ticket (508). The update, for example, can be transmitted to the workforce management engine. The update can include update information, such as the ticket identification code and a status code. The status code, for example, can indicate a status condition such as “management approval requested”. A portion of the update information can be provided to the human resource portal for display through the GUI. For example, when accessing the GUI, the employee who submitted the human resource request can see that the status information has been updated from “pending” to “management approval requested”.

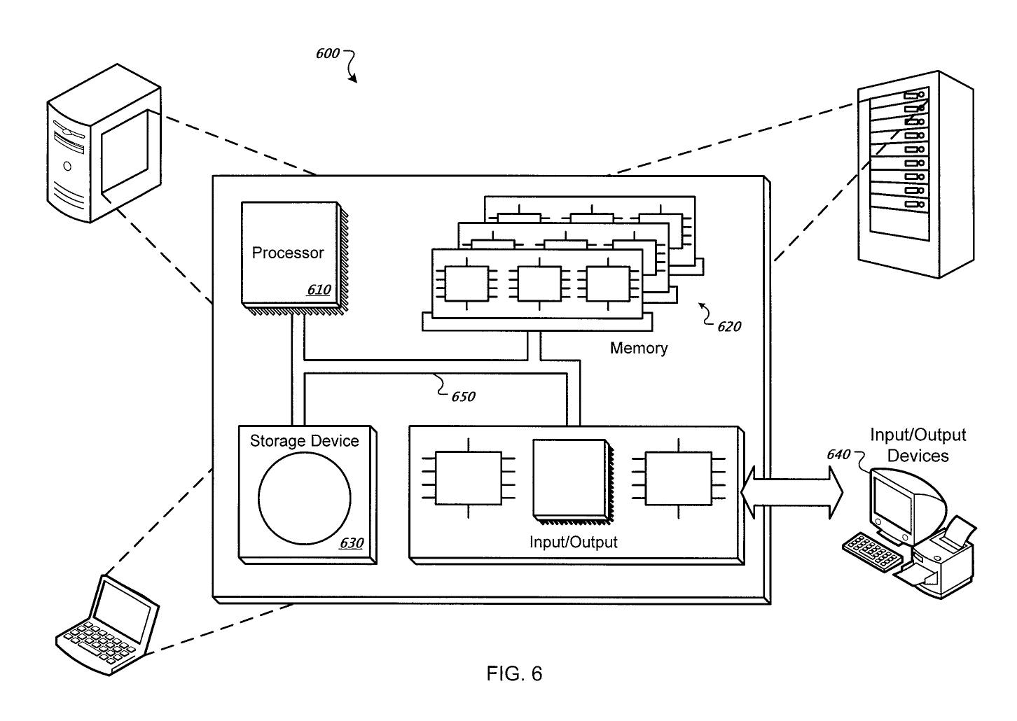

FIG. 6 is a schematic diagram of an exemplary computer system 600. The system 600 may be used for the operations described in association with the events described within the flow diagram 100, as shown in FIG. 1, according to one implementation. For example, the system 600 may be included in any or all of the HR portal 108, the workforce management system 110 or the case management system 112.

The system 600 includes a processor 610, a memory 620, a storage device 630, and an input/output device 640. Each of the components 610, 620, 630, and 640 are interconnected using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output device 640.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 may be a floppy disk device, a hard disk device, an optical disk device, or a tape device.

The input/output device 640 provides input/output operations for the system 600. In one implementation, the input/output device 640 includes a keyboard and/or pointing device. In another implementation, the input/output device 640 includes a display unit for displaying graphical user interfaces.

The features described may be implemented in digital electronic circuitry, or in computer hardware, firmware, software, or in combinations of them. The apparatus may be implemented in a computer program product tangibly embodied in an information carrier, e.g., in a machine-readable storage device for execution by a programmable processor; and method steps may be performed by a programmable processor executing a program of instructions to perform functions of the described implementations by operating on input data and generating output. The described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language, including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a CRT (cathode ray tube) or LCD (liquid crystal display) monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks include, e.g., a LAN, a WAN, and the computers and networks forming the Internet.

The computer system may include clients and servers. A client and server are generally remote from each other and typically interact through a network, such as the described one. The relationship of client and server arises by virtue of computer programs running on the respective computers and having a client-server relationship to each other.

Although a few implementations have been described in detail above, other modifications are possible. In addition, the logic flows depicted in the figures do not require the particular order shown, or sequential order, to achieve desirable results. In addition, other steps may be provided, or steps may be eliminated, from the described flows, and other components may be added to, or removed from, the described systems.

Although a few implementations have been described in detail above, other modifications are possible. In addition, the logic flows depicted in the figures do not require the particular order shown, or sequential order, to achieve desirable results. In addition, other actions may be provided, or actions may be eliminated, from the described flows, and other components may be added to, or removed from, the described systems. Accordingly, other implementations are within the scope of the following claims.

What is claimed is:

1. A system comprising:
one or more computers; and
a computer-readable medium coupled to the one or more computers having instructions stored thereon which, when executed by the one or more computers, cause the one or more computers to perform operations comprising:
receiving, at a human resource portal, a human resource request regarding an employee, the human resource portal including a graphical user interface, the human resource request including a request type and an employee identification code;
receiving, at a workforce management engine, the human resource request from the human resource portal, and generating a work ticket, the work ticket including a ticket identification code and a submission date of the human resource request;
receiving, at a case management engine, the work ticket from the workforce management engine;
assigning a case identification code to the work ticket;
associating a work flow with the work ticket, the work flow including
a status condition, and
at least one work flow task associated with a workflow task event;
transmitting an update to the workforce management engine, the updated triggered by the work flow task event, the update associated with update information including
the ticket identification code, and
a status code associated with the status condition; and
providing, through the workforce management engine, a portion of the update information to the human resource portal for display through the graphical user interface.

2. The system of claim 1, wherein the request type is a planned leave type, and the case management engine comprises:
a manage planned leave engine configured to receive a request date range associated with the human resource request, create an approval for leave work flow task, and issue an approval for leave work flow task event to the workforce management system;
a modification of leave engine configured to receive a modification of date range associated with the human resource request, create a modification of leave work flow task, and issue an action item to the workflow management system; and
a return to work engine configured to issue updated information to the workforce management system, the issuance of the updated information being triggered by a workflow task event scheduled by the case management system for the end of the request date range.

3. The system of claim 2, wherein the work flow includes work flow task events triggering a passing of control of management of the work flow between the manage planned leave engine, the modification of leave engine, and the return to work engine.

4. The system of claim 1, wherein the operations further comprise issuing an action item to of one of a computer messaging account of a direct supervisor of the employee, a payroll department, or a computer messaging account of a human resource liaison regarding the human resource request.

5. The system of claim 1, wherein the employee submits the human resource request to a workplace management worker and the workplace management worker enters the request through the human resource portal.

6. The system of claim 1,
wherein the operations further comprise assigning a case worker to the work ticket; and
wherein the work flow task events further comprise an alert event targeted to the a computer messaging account associated with the case worker assigned to the work ticket.

7. The system of claim 1, wherein the update information further includes update message text, and wherein the portion of the update information available for display through the graphical user interface includes the request ticket identification code, the status code, and the update message text.

8. The system of claim 7, wherein the update message text includes information received by the case management engine from a computer messaging account associated with a direct supervisor, an HR liaison, a workforce management worker, or a case worker.

9. The system of claim 1, wherein the update is a request ticket closure event, the operations further comprising:
modifying the status condition to one of closed prior to the providing; and
closing the work ticket.

10. The system of claim 1, the operations further comprising determining whether the human resource request is a duplicate human resource request.

11. The system of claim 1, wherein a work flow type of the work flow is one of an employee absence administration type, an exit administration type, a safety or security incident event administration type, a conduct administration type, a performance administration type, or an employee interrelations incident administration type.

12. The system of claim 11,
wherein the case management engine is included within a human resources administration engine, the human resources administration engine further including a workforce and data administration engine, a payroll engine, and a benefits engine; and
wherein the case management engine is configured to issue action items or provide information to the workforce and data administration engine, the payroll engine, or the benefits engine.

13. The system of claim 12, wherein the case management engine is further configured to track a total amount of leave requested by the employee and to determine when the total amount of leave requested by the employee exceeds a threshold leave value.

14. The system of claim 13, wherein the case management engine is further configured to submit a human resource request to the workforce management engine regarding the total amount of leave when the total amount of leave requested by the employee exceeds the threshold leave value.

15. The system of claim 11, wherein the case management engine is further configured to generate trend reports associated with each work flow type.

16. A computer-implemented method for automatically routing and managing human resource requests, the method comprising:
receiving a work ticket including a ticket identification code, a request type, a submission date, and an employee identification code from a workforce management engine, the work ticket being associated with a human resource request submitted by an employee at a human resource portal;
assigning a case identification code to the work ticket;
associating a work flow with the case identification code, the work flow including
a status condition, and
at least one work flow task associated with a workflow task event; and
transmitting an update to the workforce management engine, the transmitting triggered by the work flow task event,
wherein the update is associated with update information including the ticket identification code, and a status code associated with the status condition, and
wherein the workforce management engine provides a portion of the update information to the human resource portal for display through a graphical user interface.

17. A computer storage medium encoded with a computer program, the program comprising instructions that when executed by one or more computers cause the one or more computers to perform operations comprising:
receiving a work ticket including a ticket identification code, a request type, a submission date, and an employee identification code from a workforce management engine, the work ticket being associated with a human resource request submitted by an employee at a human resource portal;
assigning a case identification code to the work ticket;
associating a work flow with the case identification code, the work flow including
a status condition, and
at least one work flow task associated with a workflow task event; and
transmitting an update to the workforce management engine, the transmitting triggered by the work flow task event,
wherein the update is associated with update information including the ticket identification code, and a status code associated with the status condition, and
wherein the workforce management engine provides a portion of the update information to the human resource portal for display through a graphical user interface.

18. The computer storage medium of claim 17,
wherein the operations further comprise assigning a case worker to the work ticket; and
wherein the work flow task events further comprise an alert event targeted to a computer messaging account associated with the case worker assigned to the work ticket.

19. The computer storage medium of claim 17, wherein a work flow type of the work flow is one of an employee absence administration type, an exit administration type, a safety or security incident event administration type, a conduct administration type, a performance administration type, or an employee interrelations incident administration type.

20. The computer storage medium of claim 19, wherein the case management engine is configured to generate trend reports associated with each work flow type.
